(19) United States
(12) Patent Application Publication
(10) Pub. No.: US 2009/0047621 A1
(43) Pub. Date: Feb. 19, 2009

(54) TRAY ACCESSIBLE DENTAL ARTICULATORS

(76) Inventor: Tyrone A. Silva, Margate, FL (US)

Correspondence Address: EDWARD M. LIVINGSTON, PA, 963 TRAIL TERRACE DRIVE, NAPLES, FL, 34103, US

(21) Appl. No.: 11/839,360

(22) Filed: Aug. 15, 2007

(51) Int. Cl. A61C 11/08

(52) U.S. Cl. 433/60

(57) ABSTRACT

A dental articulator (1) having an upper tray (2) and a lower tray (3) connected together with an articulator arm (7) having an upper arm (27) and a lower arm (28) wherein an upper access cover (4) is removably secured to the upper tray (2) and a lower access cover (5) is removably secured to the lower tray (3). Flanges (24, 25, 31) and/or apertures (20 and 21) are provided to removably secure the access covers (4 and 5) to the trays (2 and 3). In this manner, a user may work on casts (8, 9, 29 and 30) without disassembling the articulator (1) and removing the casts (8, 9, 29 and 30). An alternate embodiment includes triangular trays (2 and 3) having at least one cast holder (35) extending from each tray (2 and 3).

### BACKGROUND OF THE INVENTION

This invention relates to dental articulators, more particularly, tray accessible dental articulators that permit access to dental casts without the need to disassemble the dental articulators.

Dental articulators are devices that mimic the movement and structure of a patient's mouth to permit a person to properly align upper and lower dental casts, or impressions, in order to examine, diagnose and/or construct dental appliances for the patient.

First, a negative impression of the teeth is taken by a dentist or other qualified person in the dental arena of a patient's upper and lower teeth. The impressions are created by filling a tray with a thermoplastic or other material and holding it against the patient's upper and lower teeth and gums. After the material has partially hardened, the trays are removed, thereby leaving negative impressions of the teeth.

Second, positive impressions of the teeth are formed by pouring a hardenable stone, such as yellow stone, into the negative impressions. The stone hardens and is then removed from the negative impressions, thus creating an accurate model of the teeth and their placement. The positive impressions are then pressed into a forming mold containing new stone which forms the base of the dental cast and bonds with the new stone. Excess yellow stone is removed, the remaining stone is permitted to harden and the final cast in now complete. The cast is then removed from the forming mold.

Next, the casts are attached to a dental articulator which mimic the patient's mouth for aligning the casts. Although current articulators do, in fact, mimic the movement of the patient's mouth, there exist several problems with the current dental articulators.

First, the user of the articulator must disassemble the articulator in order to insert or remove the cast, which is very time-consuming. Second, when the cast(s) is/are in place, the articulator typically impedes the user's ability to work on the cast(s), thereby requiring the user to remove the cast from the articulator, which once again requires disassembling the articulator, and replacing the cast within the assembled articulator. In addition, if the cast is moist, the cast is sometimes altered when removed from articulator, thereby creating an imperfect impression of the patient's teeth and gums, which could ultimately result in ill-fitting dental work.

Thus, a need exists for dental articulators which permit access to dental casts without the need to disassemble the dental articulators.

The relevant prior art includes the following references:

| U.S. Pat. No. | | |
|---|---|---|
| (U.S. unless | | |
| stated otherwise) | Inventor | Issue/Publication Date |
| 6,382,696 | Elnajjar | May 07, 2002 |
| 2002/0146661 | Pacino, Jr. et al. | Oct. 10, 2002 |
| 6,508,646 | Pacino, Jr. et al. | Jan. 21, 2003 |
| 4,200,981 | Fine | May 06, 1980 |
| 7,083,410 | Callne | Aug. 01, 2006 |
| 5,425,636 | Ghim | Jun. 20, 1995 |
| 5,385,470 | Polz | Jan. 31, 1995 |
| 2005/0250075 | Taub et al. | Nov. 10, 2005 |
| 2006/0188838 | Callne | Aug. 24, 2006 |
| 5,816,799 | Parker | Oct. 06, 1998 |
| DE 41 30 561 C1 | Zeiser | Nov. 12, 1992 |

### SUMMARY OF THE INVENTION

The primary object of the present invention is to provide tray accessible dental articulators that permit access to dental casts without the need to disassemble the dental articulators.

A further object of the present invention is to provide tray accessible dental articulators that permit a user to access dental casts quickly and easily.

An even further object of the present invention is to provide tray accessible dental articulators that permit a user to apply a predetermined amount of pressure on dental casts.

Another object of the present invention is to provide tray accessible dental articulators that permits a user to work on dental casts even if the casts are moist.

The present invention fulfills the above and other objects by providing an upper tray of a predetermined shape having a base and a rear wall, a lower tray of a predetermined shape having a base and a rear wall, an upper access cover having an access cover wall of a predetermined height removably secured to the upper tray, at least one securing means for removably securing the upper access cover to the upper tray, a lower access cover having an access cover wall of a predetermined height removably secured to the lower tray, at least one securing means for removably securing the lower access cover to the lower tray and an adjustable articulator arm having an upper arm and a lower arm which connect the upper tray rear wall to the lower tray rear wall.

To use the present invention, a user first removes the upper and lower access covers to permit access to the upper and lower tray bases. Then, the user inserts either an upper full cast or an upper partial cast into the upper tray and a lower full cast or a lower partial cast into the lower tray. The user replaces the upper and lower access covers to the upper and lower trays, respectively, and manipulates the dental articulator into various desired positions. Because the articulator arm connects the upper and lower trays, the trays move according to a predetermined track which mimics movement of a person's jaw.

An alternate embodiment of the present invention includes an upper tray and a lower tray connected via an adjustable articulator arm wherein each tray has at least one cast holder for securing a cast to the each tray.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a rear perspective view of a dental articulator of the present invention having a stop;

FIG. 2 is a top plan view of a lower tray of the dental articulator of the present invention;

FIG. 3 is a top view of a lower access cover of the dental articulator of the present invention;

FIG. 4 is a side plan view of a lower tray of the dental articulator of the present invention;

FIG. 5 is a side view of a lower access cover the dental articulator of the present invention;

FIG. 6 is a side perspective view of a dental articulator of the present invention for partial casts;

FIG. 7 is a top perspective view of a lower tray and lower access cover detached from one another of the embodiment of FIG. 6;

FIG. 8 is a front view of an articulator arm of the dental articulator of the present invention; and

FIG. 9 is a side perspective view of an alternate embodiment of a dental articulator of the present invention.

### DESCRIPTION OF THE PREFERRED EMBODIMENTS

For purposes of describing the preferred embodiment, the terminology used in reference to the numbered components in the drawings is as follows:

1. dental articulator, generally 19. base 2. upper tray 20. base first aperture 3. lower tray 21. base second aperture 4. upper access cover 22. rear wall 5. lower access cover 23. tray perimeter 6. securing means 24. first access cover flange 7. articulator arm 25. second access cover flange 8. upper full cast 26. access cover wall 9. lower full cast 27. upper arm 10. pressure means 28. lower arm 11. screw 29. upper partial cast 12. sleeve 30. lower partial cast 13. nut 31. first base flange 14. upper arm end 32. pivot point 15. lower arm end 33. bolt 16. upper arm end holder 34. housing 17. lower arm end holder 35. cast holder 18. adjustable lock nut

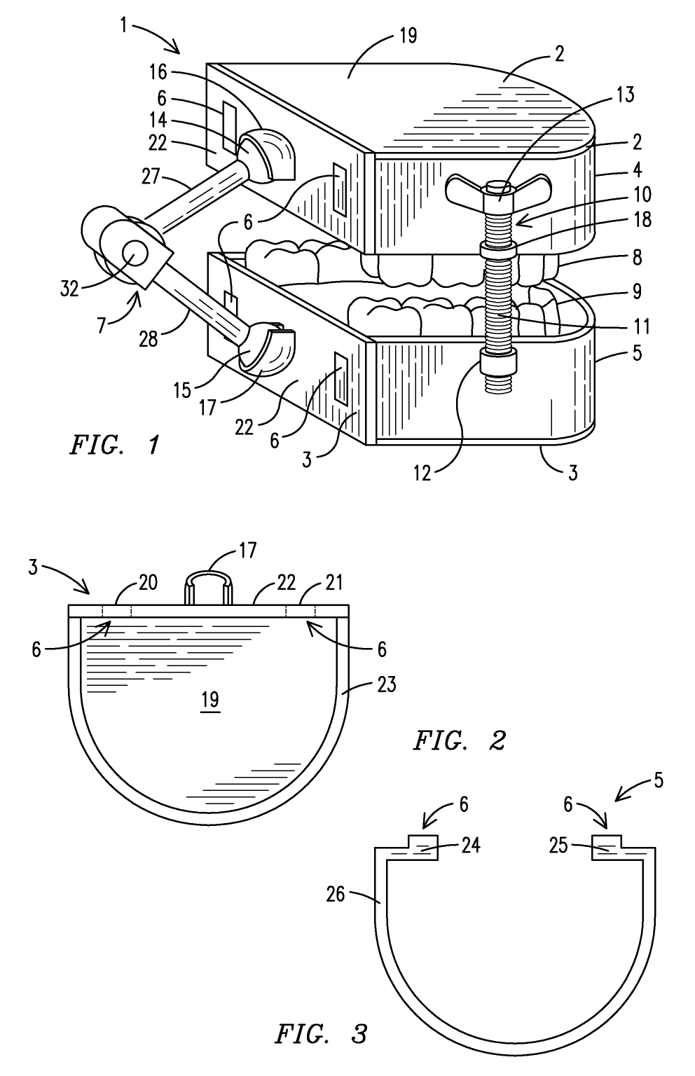

With reference to FIG. 1, a rear perspective view of a dental articulator of the present invention having a stop is shown. The dental articulator, generally 1, has an upper tray 2 of a predetermined size and shape and a lower tray 3 of a predetermined size and shape connected to one another via an adjustable articulator arm 7 having an upper arm 27 and a lower arm 28 pivotally joined together at a pivot point 23. Each tray 2 and 3 also includes a base 19 (the base 19 of the lower tray 3 is shown in FIG. 2) and a rear wall 22. An upper access cover 4 is removably secured to the upper tray 2 and a lower access cover 5 is removably secured to the lower tray 3. The access covers 4 and 5 are removably secured to the trays 2 and 3 via at least one securing means 6. An upper full cast 8 is inserted into the upper tray 2 while a lower full cast 9 is inserted into the lower tray 3. Thus, a user is permitted to work on the casts 8 and 9 by removing the covers 4 and 5, respectively, rather than disassembling the entire dental articulator 1. A locking means 10, which may be a nut 13, an adjustable lock nut 18 and a screw 11 wherein the screw 11 is insertable into a sleeve 12 located on the lower access cover 5, permits a user to apply a predetermined amount of pressure on the trays 2 and 3. Although the locking means 10 is shown wherein the screw 11 extends into a sleeve 12 located on the lower access cover 5, the sleeve 12 may be located on either of the trays 2 or 3 or on the upper access cover 4 wherein the screw 11 extends into the sleeve 12 to apply a predetermined amount of pressure on the trays 2 and 3.

The articulator arm 7 preferably includes an upper arm end 14 located at a distal end of the upper arm 27 and a lower arm end 15 located at a distal end of the lower arm 28. The arm ends 14 and 15 are preferably round in shape and are preferably housed within an upper arm end holder 16 and a lower arm end holder 17 located on the trays 2 and 3, respectively, the end holders 16 and 17 of which are also preferably round in shape. Although the arm ends 14 and 15 and end holders 16 and 17 are preferably round in shape so as to provide the most fluid-like movement, other shapes may be utilized. In FIG. 2, a top plan view of a lower tray of the dental articulator of the present invention is shown. The lower tray 3 includes a base 19, a rear wall 22 and a tray perimeter 23 which surrounds the base 19. A part of the securing means 6 for removably securing a lower access cover 5 to the lower tray 3 may include a base first aperture 20 and a base second aperture 21 which preferably extend through the rear wall 22 of the lower tray 3. In addition, the upper tray 2 may utilize at least one aperture 20 extending through the rear wall 22 as part of the securing means 6.

FIG. 3 shows a top view of a lower access cover of the dental articulator of the present invention. The lower access cover 5 may include a first access cover flange 24 and a second access cover flange 25 as part of the securing means 6. The flanges 24 and 25 are preferably sized and shaped so as to lockingly secure the lower access cover 5 to the lower tray 3. The lower access cover 5 also preferably includes an access cover wall 26 of a predetermined height to assist in retaining the lower full cast 9 within the lower tray 3. In addition, the upper access cover 5 may utilize at least one flanges 24 as part of the securing means 6 and an access cover wall 26 of a predetermined height to assist in retaining the upper full cast 8 within the upper tray 2.

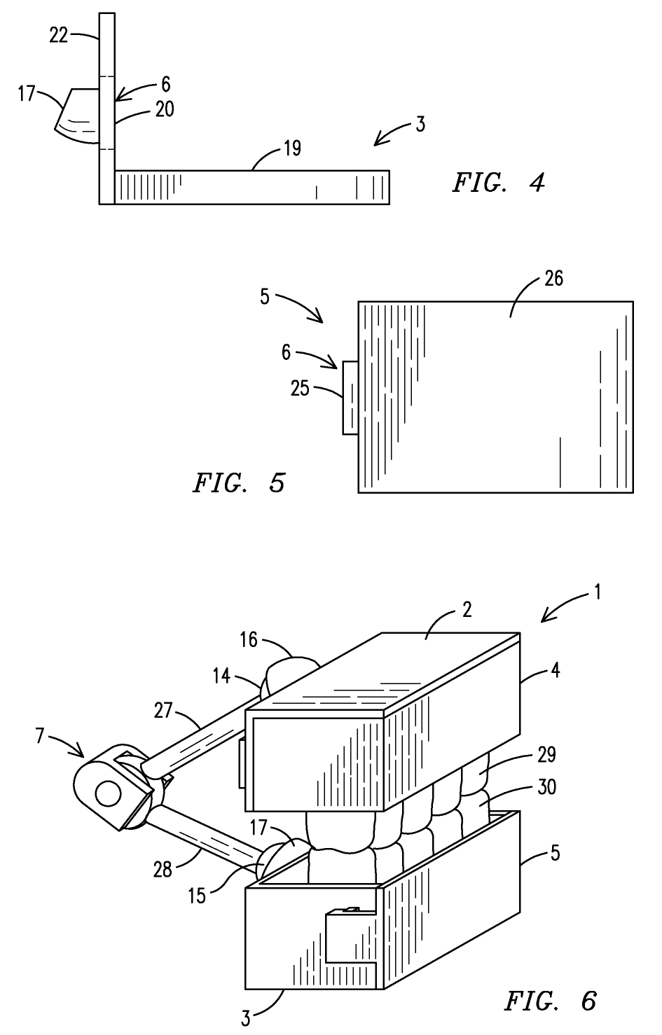

FIG. 4 shows a side plan view of a lower tray of the dental articulator of the present invention. The lower tray 3 includes a base 19 of a predetermined height and a rear wall 22 substantially perpendicular to the base 19. The first base aperture 20 extends through the rear wall 22 for acceptance of a flange 24 located on the lower access cover 5. Similarly, the first base aperture 20 extends through the rear wall 22 for acceptance of a flange 24 located on the upper access cover 4. A lower arm end holder 17 extends from the rear wall 22 for acceptance and retention of a lower arm end 15. Similarly, an upper arm end holder 16 extends from the rear wall 22 of the upper tray 2 for acceptance and retention of an upper arm end 14.

With reference to FIG. 5, a side view of a lower access cover the dental articulator of the present invention is shown. The lower access cover 5 has an access cover wall 26 of a predetermined height and, preferably, a second access cover flange 25 which forms part of the securing means 6. Similarly, a first access cover flange 24 extends from the rear wall 22 of the upper tray 2 which forms part of the securing means 6. The flanges 24 and 25 are insertable into apertures 20 and 21 which are preferably located in the rear wall 22 of the trays 2 and 3.

Next, FIG. 6 shows a side perspective view of a dental articulator of the present invention for partial casts. Similar to the dental articulator 1 for full casts 8 and 9 shown in FIGS. 1-5, the dental articulator 1 for an upper partial cast 29 and a lower partial cast 30 includes an upper tray 2 and a lower tray 3 connected via an articulator arm 7 wherein an upper access cover 4 is removably secured to the upper tray 2 and a lower access cover 5 is removably secured to the lower tray 3.

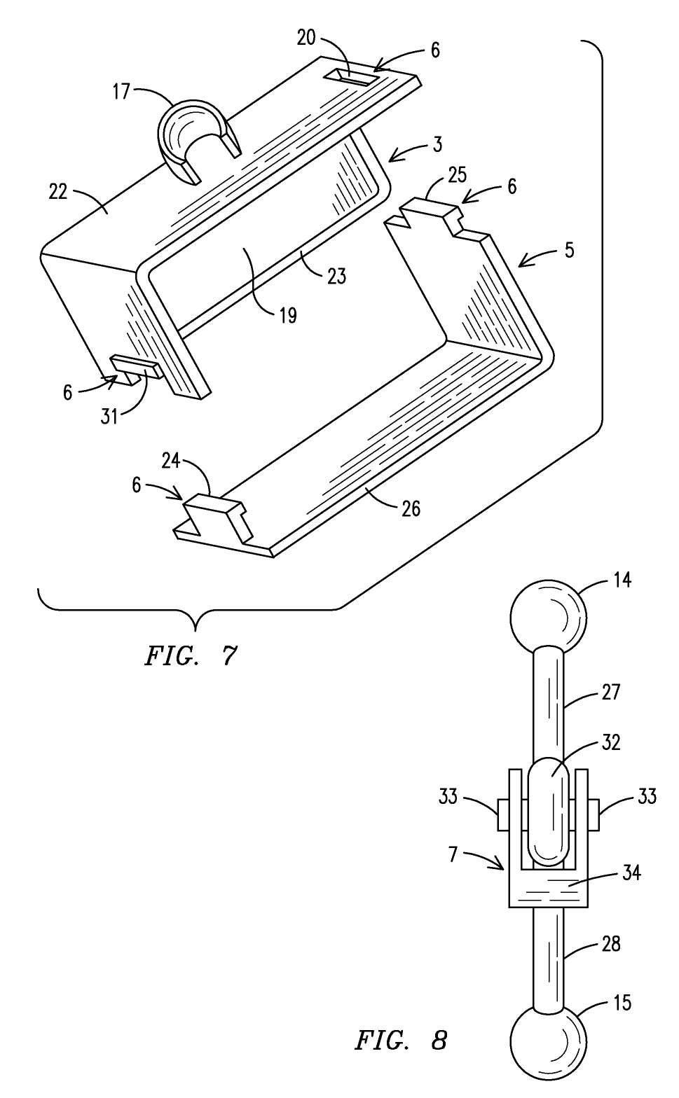

With reference to FIG. 7, a top perspective view of a lower tray and lower access cover detached from one another of the embodiment of FIG. 6 is shown. Similar to lower tray 3 for a lower full cast 9, the lower tray 3 for a lower partial cast 30 includes a rear wall 22, a lower arm end holder 17, a base 19 and a tray perimeter 23. However, rather than having two apertures 20 and 21 located on the rear wall 22 as part of the securing means 6, the securing means 6 may include a base first aperture 20 located on the rear wall 22 and a first base flange 31 located on the lower tray 3. The lower access cover 5 may include as part of its securing means 6 a first access cover flange 24 and a second access cover flange 25 wherein the first access cover flange 24 is insertable into the first base flange 31 and the second access cover flange 25 is insertable into the base first aperture 20 to removably secure the lower access cover 5 to the lower tray 3. Similarly, the upper tray 2 may include a first base flange 31 and a base first aperture 20 while the upper access cover 4 may include a first access cover flange 24 and a second access cover flange 25 which form the securing means 6.

Next, FIG. 8 shows a front view of an articulator arm of the dental articulator of the present invention. The articulator arm 7 includes an upper arm 27 and a lower arm 28 wherein a pivot point 32, which may be created by using a bolt 33 to adjustably secure the upper arm 27 to the lower arm 28, is located between the upper arm 27 and the lower arm 28. A housing 34 may surround the pivot point 32 wherein the bolt 33 preferably extends through the upper arm 27, lower arm 28 and housing 34.

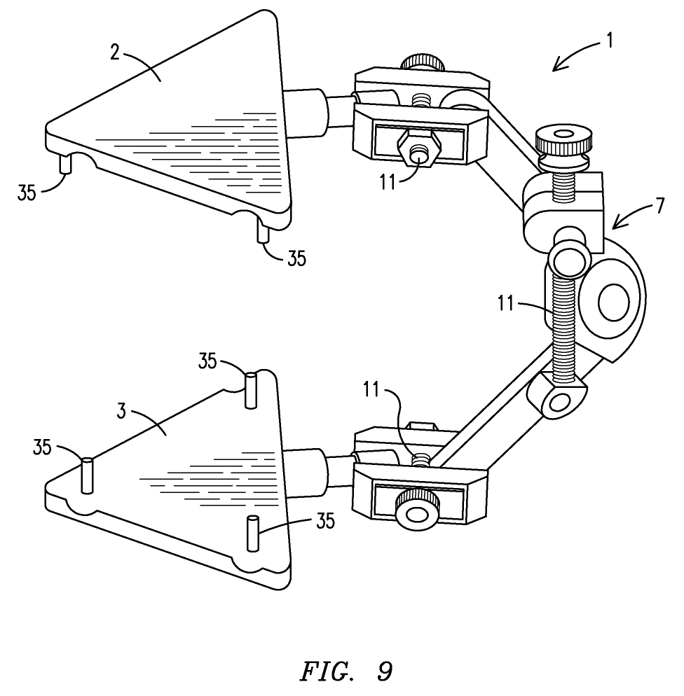

Finally, FIG. 9 shows a side perspective view of an alternate embodiment of a dental articulator of the present invention. The dental articulator 1 of this embodiment for a full arch also includes an upper tray 2 and a lower tray 3 adjustably connected to one another via an articulator arm 7. At least one cast holder 35 extends from the upper tray 2 to hold an upper full cast 8 or an upper partial cast 29. Likewise, at least one cast holder 35 extends from the lower tray 3 to hold a lower full cast 9 or a lower partial cast 30. At least one screw 11 may be located within the articulator arm 7 to permit a user to adjust the amount of pressure applied to the trays 2 and 3.

To use the present invention, a user first removes the upper and lower access covers 4 and 5 to permit access to the upper and lower trays 2 and 3. Then, the user inserts either an upper full cast 8 or an upper partial cast 29 into the upper tray 2 and a lower full cast 9 or a lower partial cast 30 into the lower tray 3. The user replaces the upper and lower access covers 4 and 5 to the upper and lower trays 2 and 3, respectively, and manipulates the dental articulator 1 into various desired positions. Because the articulator arm 7 connects the upper and lower trays 2 and 3, the trays 2 and 3 move according to a predetermined track which mimics movement of a person's jaw.

The use of the present invention will permit a user to access dental casts without the need to disassemble the dental articulators.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A dental articulator comprising:
an upper tray having a predetermined shape;
said upper tray having a base and a rear wall;
a lower tray having a predetermined shape;
said lower tray having a base and a rear wall;
an upper access cover removably secured to said upper tray;
said upper access cover having an access cover wall of a predetermined height;
at least one securing means for removably securing said upper access cover to said upper tray;
a lower access cover removably secured to said lower tray;
said lower access cover having an access cover wall of a predetermined height;
at least one securing means for removably securing said lower access cover to said lower tray; and
an articulator arm having an upper arm connected to said upper tray rear wall and a lower arm connected to said lower tray rear wall.

2. The dental articulator of claim 1 wherein:
said at least one securing means for removably securing said upper access cover to said upper tray is at least one aperture located on said upper tray rear wall and at least one flange located on said upper tray access cover.

3. The dental articulator of claim 1 wherein:
said at least one securing means for removably securing said lower access cover to said lower tray is at least one aperture located on said lower tray rear wall and at least one flange located on said lower tray access cover.

4. The dental articulator of claim 2 wherein:
said at least one securing means for removably securing said lower access cover to said lower tray is at least one aperture located on said lower tray rear wall and at least one flange located on said lower tray access cover.

5. The dental articulator of claim 1 wherein:
said at least one securing means for removably securing said upper access cover to said upper tray is at least one flange located on said upper tray and at least one flange located on said upper tray access cover.

6. The dental articulator of claim 1 wherein:
said at least one securing means for removably securing said lower access cover to said lower tray is at least one flange located on said lower tray and at least one flange located on said lower tray access cover.

7. The dental articulator of claim 5 wherein:
said at least one securing means for removably securing said lower access cover to said lower tray is at least one flange located on said lower tray and at least one flange located on said lower tray access cover.

8. The dental articulator of claim 1 wherein:
said at least one securing means for removably securing said upper access cover to said upper tray is at least one flange located on said upper tray and at least one aperture located on said upper tray access cover.

9. The dental articulator of claim 1 wherein:
said at least one securing means for removably securing said lower access cover to said lower tray is at least one flange located on said lower tray and at least one aperture located on said lower tray access cover.

10. The dental articulator of claim 8 wherein:
said at least one securing means for removably securing said lower access cover to said lower tray is at least one flange located on said lower tray and at least one aperture located on said lower tray access cover.

11. The dental articulator of claim 1 wherein:
said articulator arm upper arm has an upper arm end;
said articulator arm lower arm has a lower arm end;
said upper arm end is substantially round; and
said lower arm end is substantially round.

12. The dental articulator of claim 11 further comprising:
an upper arm end holder secured to said upper tray rear wall wherein said upper arm end is insertable into said upper arm end holder; and
a lower arm end holder secured to said lower tray rear wall wherein said lower arm end is insertable into said lower arm end holder.

13. The dental articulator of claim 11 wherein:
said articulator arm connecting said upper tray rear wall to said lower tray rear wall has a pivot point located between said upper arm and said lower arm.

14. The dental articulator of claim 1 further comprising:
at least one pressure means for applying a predetermined amount of pressure between said upper tray and said lower tray.

15. The dental articulator of claim 14 wherein:
said at least one pressure means is at least one screw insertable into a sleeve located on said lower tray.

16. The dental articulator of claim 15 further comprising:
at least one adjustable lock nut secured about said at least one screw.

17. A dental articulator comprising:
an upper tray having a predetermined shape;
said upper tray having a base and a rear wall;
a lower tray having a predetermined shape;
said lower tray having a base and a rear wall;
an upper access cover removably secured to said upper tray;
said upper access cover having an access cover wall of a predetermined height;
at least one securing means for removably securing said upper access cover to said upper tray;
said at least one securing means for removably securing said upper access cover to said upper tray is at least one aperture located on said upper tray rear wall and at least one flange located on said upper tray access cover;
a lower access cover removably secured to said lower tray;
said lower access cover having an access cover wall of a predetermined height;
at least one securing means for removably securing said lower access cover to said lower tray;
said at least one securing means for removably securing said lower access cover to said lower tray is at least one flange located on said lower tray and at least one flange located on said lower tray access cover;
an articulator arm having an upper arm connected to said upper tray rear wall and a lower arm connected to said lower tray rear wall;
said upper arm having a substantially round upper arm end;
said lower arm having a substantially round lower arm end;
a pivot point located between said upper arm and said lower arm;
an upper arm end holder secured to said upper tray rear wall wherein said upper arm end is insertable into said upper arm end holder; and
a lower arm end holder secured to said lower tray rear wall wherein said lower arm end is insertable into said lower arm end holder.

18. A dental articulator comprising:
an upper tray having a predetermined shape;
said upper tray having at least one cast holder;
a lower tray having a predetermined shape;
said lower tray having at least cast holder; and
an articulator arm having an upper arm connected to said upper tray and a lower arm connected to said lower tray.

19. The dental articulator of claim 18 wherein:
said upper tray predetermined shape is triangular.

20. The dental articulator of claim 18 wherein:
said lower tray predetermined shape is triangular.

21. The dental articulator of claim 19 wherein:
said lower tray predetermined shape is triangular.

22. The dental articulator of claim 18 wherein:
said articulator arm connecting said upper tray to said lower tray is adjustable via at least one screw.

23. The dental articulator of claim 19 wherein:
said articulator arm connecting said upper tray to said lower tray is adjustable via at least one screw.

24. The dental articulator of claim 20 wherein:
said articulator arm connecting said upper tray to said lower tray is adjustable via at least one screw.

25. The dental articulator of claim 21 wherein:
said articulator arm connecting said upper tray to said lower tray is adjustable via at least one screw.
